(19) United States
(12) Patent Application Publication
(10) Pub. No.: US 2006/0032989 A1
(43) Pub. Date: Feb. 16, 2006

(54) Mounting apparatus for marine radio

(76) Inventor: John A. Badiali, Nokomis, FL (US)

Correspondence Address: GIFFORD, KRASS, GROH, SPRINKLE & CITKOWSKI, P.C, PO BOX 7021, TROY, MI, 48007-7021, US

(21) Appl. No.: 11/203,889

(22) Filed: Aug. 15, 2005

Related U.S. Application Data
(60) Provisional application No. 60/601,812, filed on Aug. 16, 2004.

(51) Int. Cl. G12B 9/00

(52) U.S. Cl. 248/27.1

(57) ABSTRACT

A mounting structure for radios which supports a radio in an opening in a wall or bulkhead of a boat in which a mounting member of a top and pair of side panels is made of plastic material in a substantially flat member which permits the side panel to be folded relative to the top for detachable engagement with a frame bordering the instrument panel of the radio. The frame and mounting are fastened to the radio by two fasteners for insertion as an assembly in the wall opening. The mounting structure shields the top and sides of the radio and protects it from spray and moisture. The mounting structure is provided with tabs to facilitate installation of the assembled radio and mounting structure.

### CROSS-REFERENCE TO RELATED APPLICATIONS

This application claims priority from U.S. Provisional Patent Application Ser. No. 60/601,812 filed Aug. 16, 2004, the content of which is incorporated by reference.

### BACKGROUND OF THE INVENTION

This invention relates to mounting apparatus for radios and more particularly to mounting apparatus for use in the marine environment where the apparatus and supported radio are subjected to spray and moisture.

### FIELD OF THE INVENTION

AM and FM radios are installed on many boats as standard equipment. Such installations typically use automotive type radios that have an industry standard for the dimensions of the opening into which the radio will fit. The typical radio for installation comes with a metal sleeve which telescopically receives a radio. Upon installation of the sleeve into an opening in a wall such as an instrument panel or bulkhead, metal tabs on the sleeve are bent into position to hold the sleeve relatively rigid to the mounting surface. When the radio is installed into the sleeve the entire weight of the radio and sleeve are cantilevered from the mounting surface and the radio tends to sag downwardly at the rear to open the gap at the face of the instrument. This causes leaks resulting in water damage and often failure of the radio.

It is an object of the invention to provide a combination shield and bracket which is made of plastic to resist corrosion and is substituted for the metal sleeve used in the automotive installations and heretofore in marine installations.

It is an objection of the invention to add a mounting apparatus for radios which acts to cover the top of the radio and to produce a water shield at the opposite sides depending downwardly from the top.

Another object of the invention is to provide a mounting apparatus for radios that facilitates support of the radio during installation relative to a mounting surface.

A further object of the invention is to provide an apparatus for mounting radios in which the bottom of the radio is exposed to offer better air circulation for cooling the instrument.

Still another object of the invention is to provide a mounting apparatus for radios which affords support for the radio while it is being installed.

Yet another object of the invention is a mounting apparatus for radios that can be manufactured at a savings in manufacturing costs by molding it in a flat shape rather than molding it in a preformed state.

### SUMMARY OF THE INVENTION

The objects of the invention are attained by a mounting apparatus for radios that is molded of plastic in a flat shape to form a top for covering the upper surface of a radio with depending sides to cover both sides of the radio. The top and two sides are provided with grooves that receive complementary tongues formed on the frame or bezel surrounding the face of the instrument or radio. When the grooves are fitted to receive the tongues, the radio can be installed and fastened to the mounting structure after which it can be installed as a single assembly in an opening in a bulkhead or instrument panel. The installation makes a radio and its mounting structure rigid with the wall in which it is mounted and at the same time protects the radio from damage by moisture and spray.

### DESCRIPTION OF THE DRAWINGS

FIG. 1 is an exploded view of the two main portions of the mounting apparatus for a marine radio including a frame and a support bracket;

FIG. 2 is an assembled position of the radio in the mounting apparatus in readiness for insertion in an opening in a bulkhead or wall of a boat or automobile;

FIG. 3 is a front elevation of the frame and support bracket during assembly of the two parts of the assembly in FIG. 1. in cross section to illustrate the relative position of the mounting apparatus and wall;

FIG. 4 is a cross section taken on line 4-4 in FIG. 3 showing the support bracket and frame after assembly and inserted in an opening in a wall or bulkhead shown in cross section to illustrate the relative position of the mounting apparatus and wall;

FIG. 5 is an edge view of a portion of the support bracket in its as-molded state; and

FIG. 6 is a plan view of the support bracket in its as-molded state.

### DETAILED DESCRIPTION

The mounting apparatus for mounting radio is designated generally at 10 and includes a bezel or frame 12 which forms a border for a rectilinear opening receiving a radio 14. A shroud or support bracket 16 covers the top and sides of the radio 14 and attaches to the frame 12 to act as a shield and support for the radio.

The frame 12 has a rectilinear shape with an opening 20. The entire perimeter of the opening 20 is formed with a tongue 22 adapted to receive complementary groove portions 24 formed on the top and outside forward portions of the shroud 16.

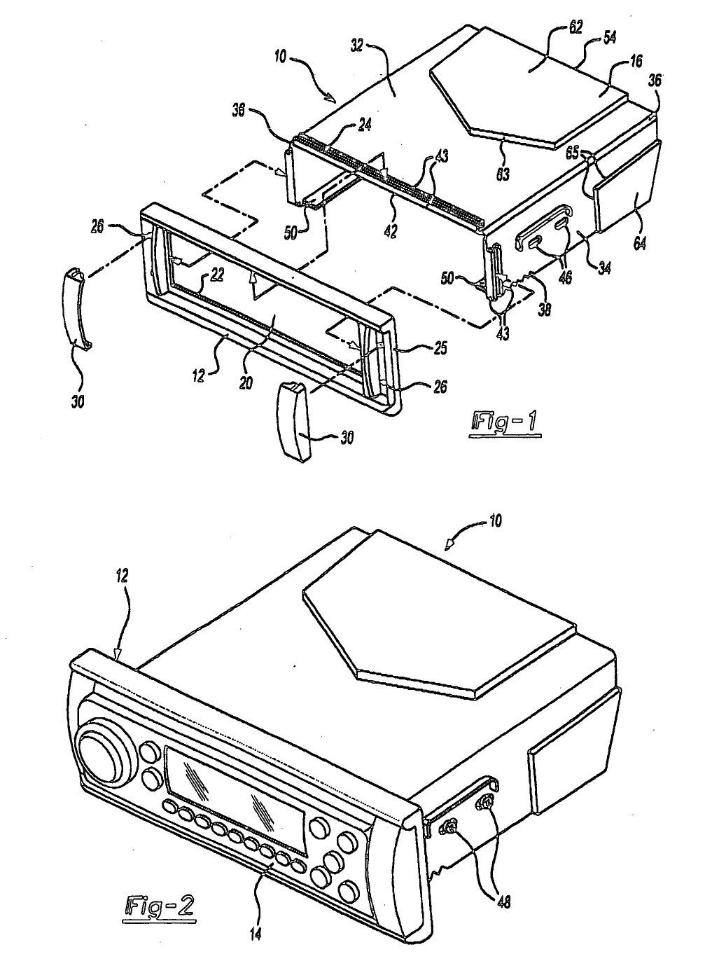

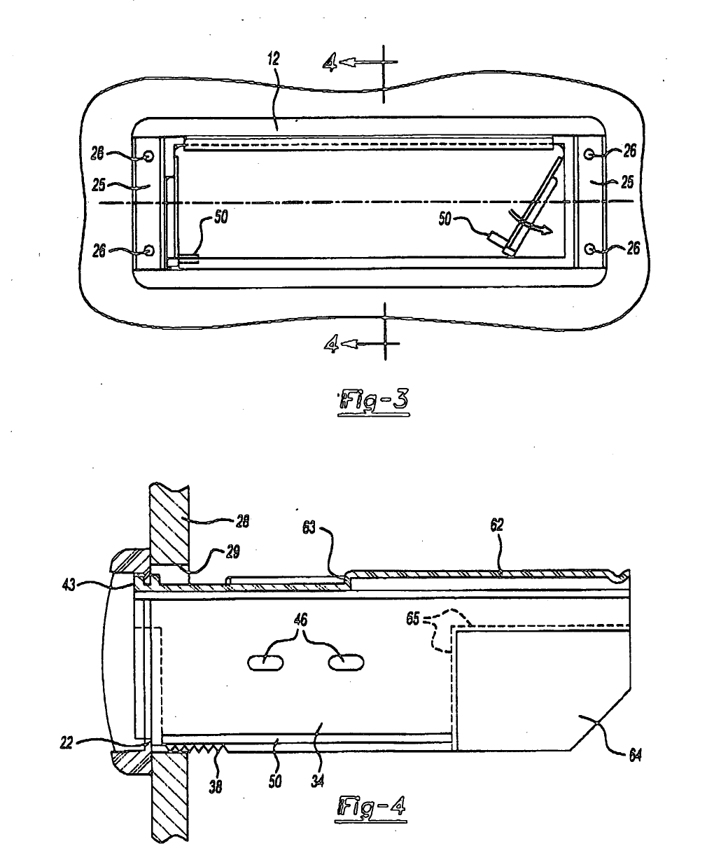

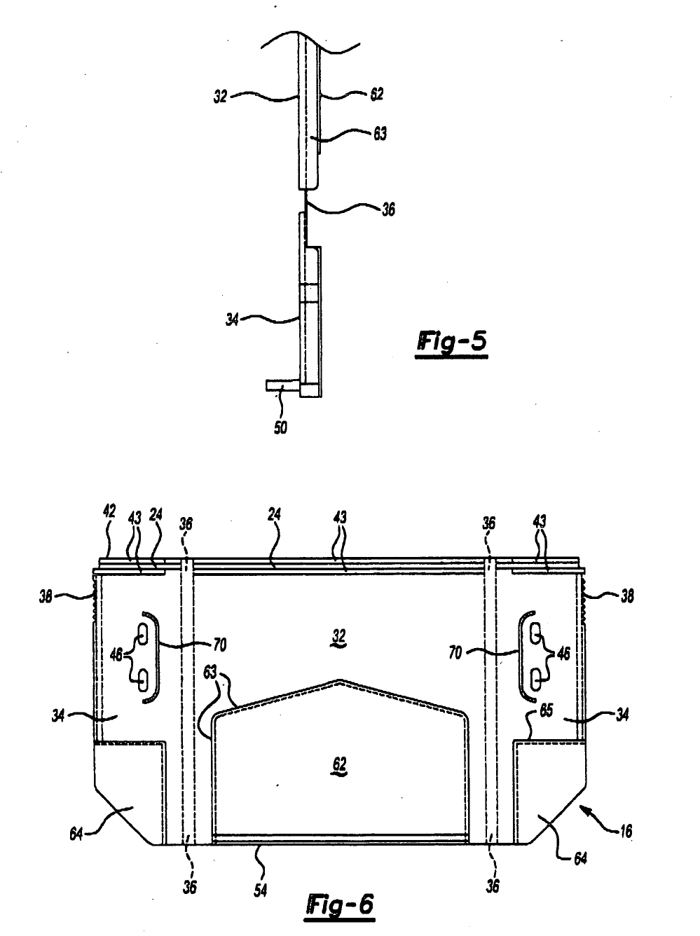

The frame 12 has opposed vertical sides formed with a concealed flange 25 having holes 26 as seen in FIG. 1 for receiving fasteners such as bolts or screws to fasten the entire assembly including the frame 12, the shroud 16 and radio 14 to a bulkhead 28 or other form of mounting wall. In this condition and as seen in FIG. 4, the radio 14 and shroud 16 pass through an opening 29 in bulkhead 28 and are positioned at one side of the bulkhead and the bezel or frame 12 is at the opposite side. The flange 25 is covered with end pieces 30 seen in FIGS. 1 and 2 acting to cover the fasteners and complete the appearance of the frame.

The shroud 16, frame 12 and end pieces 30 are molded of plastic material. The shroud 16 is molded as a single unitary member in a generally flat form as seen in FIG. 6. Shroud 16 has a rectangular top panel 32 and side panel portions 34 joined to the top panel 32 with long hinge portions 36. The hinge portions 36 form live hinges and are thinner than the rest of the panel members 32 and 34 to facilitate bending.

The two side panels 34 have teeth 38 formed at their bottom edge adjacent the forward edge 42 of the shroud 16 as best seen in FIGS. 1, 4 and 6. These teeth facilitate mounting of the assembly as will be explained.

The groove 24 is defined by opposed lip portions 43 formed adjacent to the forward frame edge 42 on the top surface 44 of the shroud 16 as seen in FIG. 6. The groove 24 and opposed lip portions 43 extends for the full width of the top panel 32 and is interrupted at the hinge portions 36 and continues to extend into each of the two side panels 34. This groove 24 is complementary to and receives the tongue portion 22 formed on the frame or bezel 12 to form a connecting means.

Each of the side panels 34 has two elongated mounting holes 46 seen in FIGS. 2 and 4 to receive fasteners or studs 48 (seen in FIG. 2) threaded into the radio 14. Also, each of the side panels 34 has a narrow ledge or flange 50 as seen in FIGS. 6 and 7 acting to engage the bottom edge of the radio 14 adjacent to its opposite sides to assist in supporting the radio.

The rearward edge of the shroud 16 remote from the frame 12 and edge 42 is designated at 54. The inside surface 44 of the top panel 32 forms a shallow recess to result in a raised panel portion 62 that serves to form an air space between the radio chassis and the shroud 16. Edges of the raised panel portion 62 also act as ribs to reinforce and stiffen the rectangular top panel 32 of the shroud 16. Each of the side panels 34 also is provided with a raised panel portion 64 with edges or ribs 65 that offers the advantages of ventilation and stiffening.

The side panel portions 34 are each provided with a water shed guard 70 that extends above the two openings 46 receiving studs to hold the radio in the mounting structure. The guard is intended to divert any moisture that might tend to enter the openings 46 and cause damage.

To install a radio in an opening in a bulkhead or wall of a boat or vehicle the frame 12 and shroud 16 are assembled. This is accomplished by bending the shroud 16 so that the side panels 34 are at an acute angle to the top panel 32 as seen at the right side of FIG. 3 of shroud 16 so that the vertical height of the assembly is reduced to fit the opening 20. Thereafter the groove 24 in panel 32 is mated with the tongues 22 formed at one of the long sides of the perimeter of the opening 20 to the frame 12. The side panels 34 are then hinged downwardly perpendicular to the top so that the groove 24 in side panels 34 are engaged with the tongue portions 22 at the opposite sides of frame 12. The tendency of the side panels 34 to return to their as-molded condition keeps the shroud 16 and bezel or frame 12 assembled during the installation procedure. This structure is ready to receive the radio 14 which slides through the opening 20 in frame 12. The radio 14 is fastened to the shroud 16 by the fasteners 48 inserted through openings 46. This forms a rigid assembly which can be inserted in an opening in a wall or bulkhead 28.

The assembly made up of the radio 14, shroud 16 and frame 12 is supported and cantilevered from the frame 12 so that the tendency of the assembly is to sag downwardly at its rear end. This causes difficulties in the installation which is minimized by the teeth 38 in the side panels adjacent to the frame 12. As seen in FIG. 4, the teeth 38 engage the bottom edge of the opening 29 in the wall 28 in which the installation is being made to resist movement of the frame 12 away from the mounting wall 28 while fasteners are installed through holes 26 into the mounting wall to fix the assembly in position. After the fasteners are in position the two end covers 30 can be snapped into position to conceal the fasteners and to form an attractive outside appearance to the installation.

In the installed condition the shroud 16 and frame 12 are fixed relative to the radio 14 which is shielded at its top and sides and at the frame 12 from moisture and spray. Also the mounting apparatus 10 which is made of plastic, resists rust and corrosion which is common to metal mounting arrangements, particularly in a marine environment.

In some instances radios may be provided with integral frames or bezels 12. In such cases the mounting structure or shroud 16 still is useful in performing its function of shielding the radio from spray and moisture when attached to the radio by fasteners 46 in openings 48.

1. A radio mounting structure comprising:
a frame having a rectilinear opening to receive the face of a radio instrument and adapted for fastening to a wall having an opening receiving said radio instrument;
a support member having a top panel and a pair of side panels for engaging the top and opposed sides of a radio instrument and being detachably attached thereto;
connector means having complementary attached portions associated with said frame and with said support member for connecting said mounting structure to said frame with side panels depending from said top panel;
said frame, mounting structure and radio forming a rigid assembly insertable as a unit in an opening in a wall; and
fastening means connecting said frame of said assembly to said wall.

2. The mounting structure of claim 1 wherein said top panel and side panels are unitary and initially in the same plane, said side panel being foldable relative to said top panel to depend from said top panel.

3. The mounting structure of claim 1 wherein said side panels are foldable in relation to said top panel.

4. The mounting structure of claim 1 in which said side panels have gripper teeth to engage a lower edge of an opening in a wall to temporarily hold said assembly in position during installation.

5. A mounting structure for radios comprising:
a frame member having a rectilinear opening to frame the face of a radio said frame having a tongue connector formed at its perimeter of said rectilinear opening;
a unitary support member having a top panel and side panels formed as a unit to cover the top and opposite sides of the radio;
said support member having a groove connector formed at forward edges of said top panel and side panels;
said tongue connector and groove being complementary to each other and operative to engage and hold said frame member connected to said support member; and
openings formed by said side panels to receive threaded fasteners into a radio to form a rigid assembly ready for attachment as a unit in an opening in a wall.

6. The mounting structure of claim 5 wherein said side panels are foldable in relation to said top panel.

7. The mounting structure of claim 5 wherein said mounting structure and frame are formed of plastic material.

8. The mounting structure of claim 5 said top panel and side panels are unitary and initially in the same plane, said side panel being foldable relative to said top panel to depend from said top panel.

9. The mounting structure of claim 5 in which said side panels have gripper teeth to engage a lower edge of an opening in a wall to temporarily hold said assembly in position during installation.

10. The mounting structure of claim 5 wherein said top and side panels have a shallow recess occupying a part of said panels to afford air circulation between said mounting structure and a radio instrument and forming a rib at the edges of said recesses to reinforce said panels.

11. A mounting structure for radios comprising:
a frame member having a rectilinear opening to frame the face of a radio said frame having a tongue connector formed at the perimeter of said rectilinear opening;
a unitary support member having a top panel and side panels formed as a unit to cover the top and opposite sides of the radio;
said support member having a groove connector formed at forward edges of said top panel and side panels;
said tongue connector and groove being complementary to each other and operative to engage and hold said frame member connected to said support member; and
openings formed by said side panels to receive threaded fasteners into a radio to form a rigid assembly ready for attachment as a unit in an opening in a wall.

12. The mounting structure of claim 11 wherein said side panels are foldable in relation to said top panel

13. The mounting structure of claim 11 wherein said support members are formed of plastic material and said top and side panels are unitary with hinge areas formed at the juncture of said top and side members.

14. The mounting structure of claim 11 wherein said frame forms openings to receive fasteners for attachment of said rigid assembly to a wall.

15. The mounting structure of claim 11 wherein said top cover and side covers are unitary and initially in substantially the same plane, said side panels being foldable relative to said top panel to depend from said top member.

16. The mounting structure of claim 11 wherein said side panels are foldable at the hinges joining said side panels to said top member.

17. The mounting structure of claim 11 wherein said side panels are detachably connectable to said bezel by said complementary tongue and groove connectors.

18. The mounting structure of claim 11 wherein said side panels each have a ledge along a lower edge for engaging and supporting a radio.

19. The mounting structure of claim 11 in which said side panels have gripper teeth to engage a lower edge of an opening in a wall to temporarily hold said assembly in position during installation.

20. The mounting structure of claim 11 wherein said top and side panels have a shallow recess occupying a part of said portion to afford air circulation between said mounting structure and a radio instrument and forming a rib at the edges of said recesses to reinforce said panels.
